(19) United States
(12) Patent Application Publication
(10) Pub. No.: US 2013/0280571 A1
(43) Pub. Date: Oct. 24, 2013

(54) LITHIUM ION SECONDARY BATTERY

(71) Applicants: Takashi Eguchi, Nagaokakyo (JP); Katsunori Suzuki, Nagaokakyo (JP); Youshin Yagi, Hitachinaka (JP)

(72) Inventors: Takashi Eguchi, Nagaokakyo (JP); Katsunori Suzuki, Nagaokakyo (JP); Youshin Yagi, Hitachinaka (JP)

(73) Assignee: Hitachi Vehicle Energy, Ltd., Hitachinaka-shi, Ibaraki (JP)

(21) Appl. No.: 13/995,671

(22) PCT Filed: Dec. 15, 2011
(86) PCT No.: PCT/JP2011/079041

§ 371 Date: Jun. 19, 2013

(30) Foreign Application Priority Data
Dec. 24, 2010 (JP) 2010-288257

(51) Int. Cl. H01M 10/04

(52) U.S. Cl. CPC H01M 10/0431
USPC 429/94; 429/163

(57) ABSTRACT

A lithium ion secondary battery is disclosed in which an electrode assembly is accommodated in a battery container, the electrode assembly including a positive electrode having a positive electrode mixture layer containing a lithium transition metal composite oxide, a negative electrode having a negative electrode mixture layer for occluding/releasing lithium ions, and a separator disposed to inner and outer peripheries of the positive electrode and the negative electrode. The lithium ion secondary battery being charged with a non-aqueous electrolyte containing a lithium salt, wherein the relation shown by the following formula (I) is satisfied:

0.57<b×c/a<0.60 (I)

assuming the area of the positive electrode mixture layer as a, the area of the separator as b, and the porosity of the separator as c.

### TECHNICAL FIELD

The present invention relates to a lithium ion secondary battery. More specifically, the invention relates to a lithium ion secondary battery capable of improving output characteristics.

### BACKGROUND ART

In lithium ion secondary batteries, development has been made for improving the output characteristics. A lithium ion secondary battery has an electrode assembly comprising separators disposed to inner and outer peripheries of a positive electrode having a positive electrode mixture layer and a negative electrode having a negative electrode mixture layer.

The positive electrode mixture layer comprises a lithium-containing oxide and the negative electrode mixture layer comprises a material such as graphite capable of occluding/releasing lithium ions. The separator has pores for permitting the lithium ions to permeate therethrough. Lithium is stored in the state of ions between the positive electrode mixture layer and the negative electrode mixture layer during charging.

In the lithium ion secondary battery described above, there is known a method of improving a battery life by defining a ratio between the sum of the thickness of the positive electrode active material (constituent material of the positive electrode mixture) layer and the thickness of the negative electrode active material (constituent material of the negative electrode mixture) layer opposing to each other with a separator interposed therebetween and the thickness of the separator within a predetermined range, and defining an air permeability of the separator within a required range (for example, refer to Patent Document 1).

### PRIOR ART LITERATURE

### Patent Document

Patent Document: JP-2003-303625-A

### SUMMARY OF THE INVENTION

### Problem to be Solved by the Invention

In the prior art literature 1, only the improvement in the battery life is investigated and increase in the battery power density is not investigated. Based on the result of the present invention, the battery power density could be increased by optimization of a factor different from the factor investigated in the prior art literature 1. That is, the subject of the present invention is to improve the battery power density.

### Means for Solving the Problem

According to a first embodiment of the invention, in a lithium ion secondary battery, an electrode assembly is accommodated in a battery container, the electrode assembly including a positive electrode having a positive electrode mixture layer containing a lithium-transition metal composite oxide, a negative electrode having a negative electrode mixture layer for occluding/releasing lithium ions, and a separator disposed to inner and outer peripheries of the positive electrode and the negative electrode, the lithium ion secondary battery being charged with a non-aqueous electrolyte containing a lithium salt, wherein a relation shown by the following formula (I) is satisfied:

0.57<b×c/a<0.60 (I)

assuming the area of the positive electrode mixture layer as a, the area of the separator as b, and the porosity of the separator as c.

According to a second embodiment of the present invention, in the lithium ion secondary battery of the first embodiment, the electrode assembly preferably has a cylindrical shape and the area of the separator preferably includes an area of a preceding winding region and an area of a succeeding winding region.

According to a third embodiment of the present invention, in the lithium ion secondary battery of the first or the second embodiment, the separator preferably has a porosity of 43 to 50.

According to a fourth embodiment of the present invention, in the lithium ion secondary battery of the first or the second embodiment, the separator preferably has a porosity of 45 to 50.

According to a fifth embodiment of the present invention, in the lithium ion secondary battery in any of the first to fourth embodiments, the separator preferably has a thickness of 18 to 25 μm.

### Effects of the Invention

According to the present invention, since the ratio between the area of the positive electrode mixture layer of the positive electrode and the area of the pores in the separator is optimized, an appropriate amount of a non-aqueous electrolyte is possessed between the positive electrode mixture layer and the negative electrode mixture layer and a resistance between the positive electrode and the negative electrode is decreased. This can provide an effect of improving a battery power density.

### BRIEF DESCRIPTION OF THE DRAWINGS

FIG. 1 is a cross sectional view of an embodiment of a lithium ion secondary battery of the invention.

FIG. 2 is an exploded perspective view of the lithium ion secondary battery illustrated in FIG. 1.

FIG. 3 is a partially cut-away perspective view for illustrating details of an electrode assembly illustrated in FIG. 1.

FIG. 4 is a partially developed plan view of positive/negative electrodes and a separator of the electrode assembly illustrated in FIG. 3.

FIG. 5 is a view for explaining the porosity of the separator illustrated in FIG. 3, in which (a) is an enlarged cross sectional view and (b) is an enlarged plan view.

FIG. 6 is an enlarged cross sectional view for explaining the effect of the invention.

FIG. 7 is a graph showing the effect of the invention.

### MODE FOR CARRYING OUT THE INVENTION

### (Entire Constitution of a Secondary Battery)

A lithium ion secondary battery of the invention is to be described for a cylindrical battery as an embodiment in conjunction with drawings.

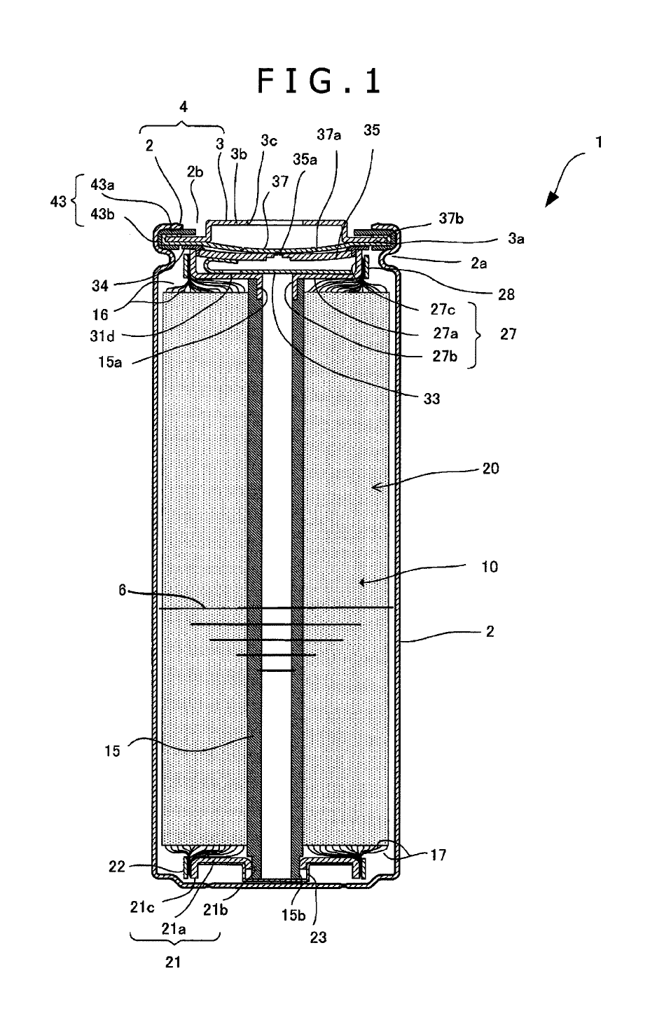

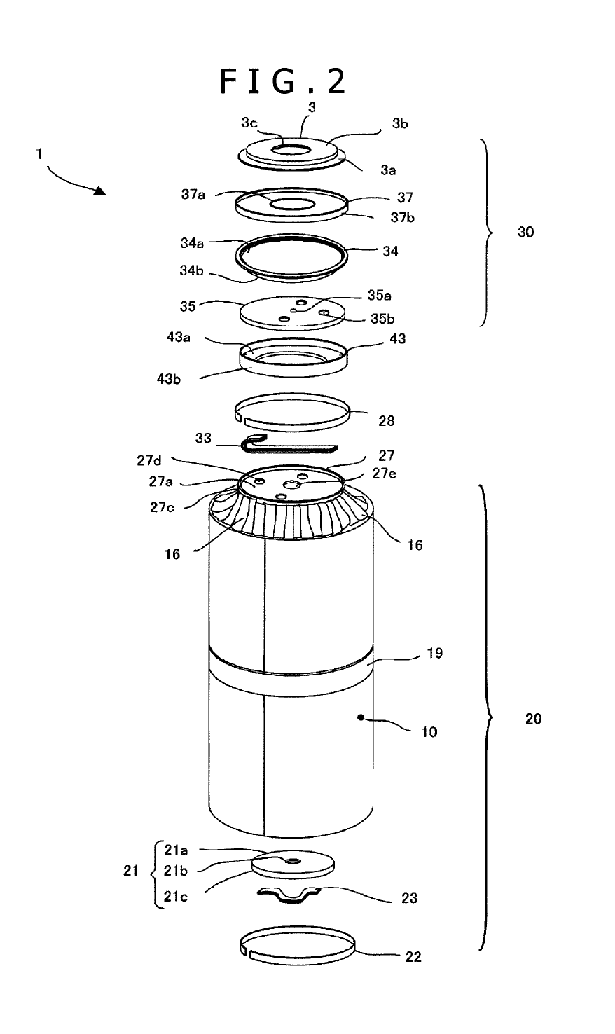

FIG. 1 is a cross sectional view of the lithium ion secondary battery of the invention, and FIG. 2 is an exploded perspective view of a cylindrical secondary battery illustrated in FIG. 1.

A cylindrical lithium ion secondary battery 1 has a size, for example, of 40 mmφ outer diameter and 100 mm height.

The lithium ion secondary battery 1 has a battery container 4 of a structure in which a bottomed cylindrical battery can 2 and a hat-shaped battery lid 3 are crimped with a seal member 43 usually referred to as a gasket being interposed between them and tightly sealed to the outside. The bottomed cylindrical battery can 2 is formed by pressing a metal plate comprising, for example, iron or stainless steel in which a plating layer such as of nickel is formed over the entire inner surface and outer surface. The battery can 2 has an opening 2b on the upper end portion as an open side thereof. A groove 2a protruding inward of the battery can 2 is formed to the battery can 2 on the side of the opening 2b. In the inside of the battery can 2, respective constituent members for power generation to be described later are accommodated in the inside of the battery can.

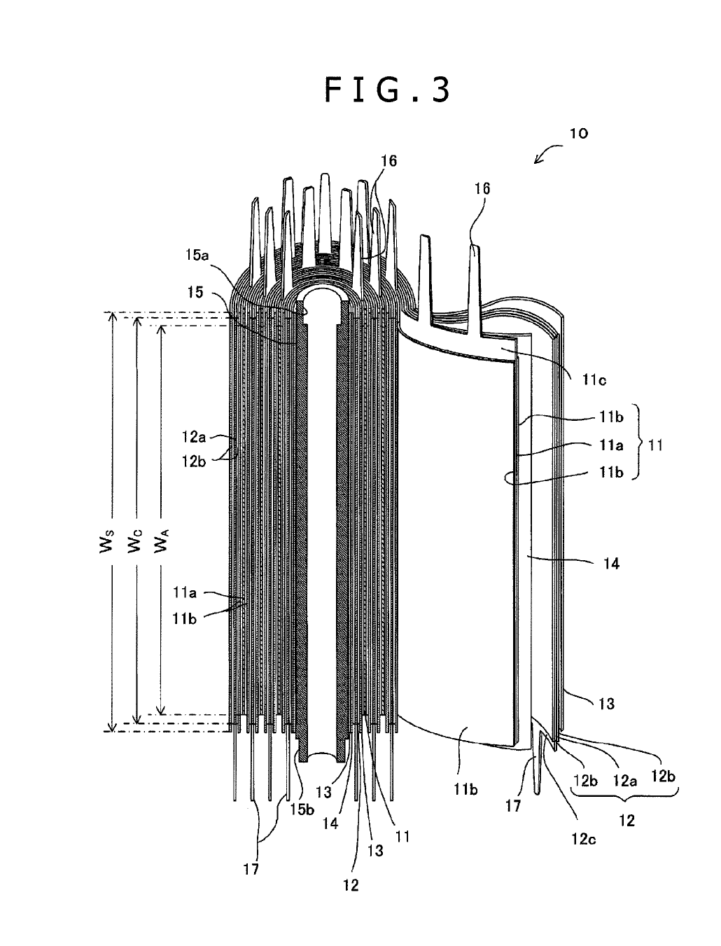

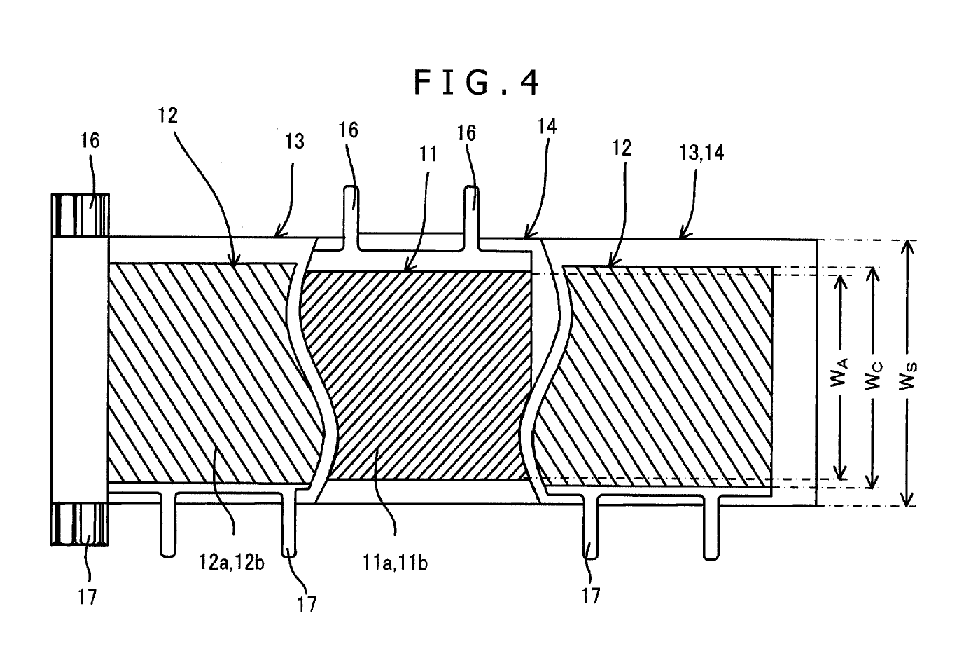

An electrode assembly 10 has an axial core 15 at the central portion, and a positive electrode, a negative electrode, and a separator are wound around the axial core 15. FIG. 3 is a perspective view showing details of the electrode assembly 10 in a partially cut-out state. Further, FIG. 4 is a plan view in a state of partially developing the positive/negative electrodes and a separator of the electrode assembly illustrated in FIG. 3.

As illustrated in FIG. 3, the electrode assembly 10 has a configuration in which a positive electrode 11, a negative electrode 12, and first and second separators 13 and 14 are wound around the axial core 15.

The axial core 15 has a hollow cylindrical shape and the negative electrode 12, the first separator 13, the positive electrode 11, and the second separator 14 are laminated and wound around in this order. The first separator 13 and the second separator 14 are wound each by several turns (one turn in FIG. 3) to the inside of the negative electrode 12 at the innermost periphery. At the outermost periphery of the electrode assembly 10, the negative electrode 12 and the separator 13 wound around the outer periphery thereof are provided in this order (refer to FIGS. 3 and 4). The first separator 13 at the outermost periphery is secured by an adhesive tape 19 (refer to FIG. 2).

FIG. 4 shows a state that the negative electrode 12 and the first separator 13 are cut out each at an intermediate portion, and the positive electrode 11 and the second separator 14 are exposed at cutout portions.

The positive electrode 11 is formed of an aluminum foil having an elongate shape, and has a positive electrode sheet 11a and a treated positive electrode portion where a positive electrode mixture layer 11b is formed on both sides of the positive electrode sheet 11a. An upper side edge along the longitudinal direction of the positive electrode sheet 11a forms a not-treated positive electrode mixture portion 11c where the positive electrode mixture layer 11b is not formed and an aluminum foil is exposed. In the not-treated positive-electrode portion 11c, a number of positive electrode leads 16 protruding upward in parallel with the axial core 15 are formed integrally each at an equal distance.

The positive electrode mixture comprises a positive electrode active material, a positive electrode conductive material, and a positive electrode binder. The positive electrode active material preferably comprises a lithium metal oxide or a lithium transition metal oxide. For example, the material comprises lithium cobaltate, lithium manganate, lithium nickelate, lithium composite metal oxide (including a metal oxide of lithium containing two or more elements selected from cobalt, nickel, and manganese). The positive electrode conductive material has no particular restriction so long as the material can assist transmission of electrons generated by the lithium occluding/releasing reaction in the positive electrode mixture to the positive electrode. Since the lithium composite metal oxide containing the transition metal has an electroconductivity, the material per se may be used as the positive electrode conductive material. Particularly, preferred characteristics can be obtained by using a lithium transition metal composite oxide comprising lithium cobaltate, lithium manganate, and lithium nickelate, which are the materials described above.

The positive electrode binder is not particular restricted so long as it can bind the positive electrode active material and the positive electrode conductive material, and can bind the positive electrode mixture layer 11b and the positive electrode sheet 11a and is not degraded greatly in contact with the non-aqueous electrolyte. An example of the positive electrode binder includes polyvinylidene fluoride (PVDF) and fluoro rubber. The method of forming the positive electrode mixture layer 11b is not particularly restricted so long as the positive electrode mixture layer 11b is formed on the positive electrode sheet 11a. An example of the method of forming the positive electrode mixture layer 11b includes a method of coating a dispersed solution of the constituent material of the positive electrode mixture on the positive electrode sheet 11a.

The method of forming the positive electrode mixture layer 11b to the positive electrode sheet 11a includes, for example, a roll coating method, a slit die coating method, etc. A slurry formed by adding N-methyl-pyrrolidone (NMP) or water as an example of a solvent for a dispersed solution to the positive electrode mixture and kneading them is coated uniformly on both surfaces of an aluminum foil of 20 μm thickness and dried, and then they are cut by die cutting or the like. The coating thickness of the positive electrode mixture is, for example, about 40 μm on one side. When the positive electrode sheet 11a is cut, positive electrode leads 16 are formed integrally. The length for all of the positive electrode leads 16 is substantially identical. After forming the positive electrode leads 16 by cutting, the positive electrode mixture is preferably hot pressed by press rollers to increase the contact surface between the particles of the positive electrode mixture and with the positive electrode sheet 11a, thereby lowering a DC current resistance. Further, since the thickness of the positive electrode mixture layer 11b is decreased by hot pressing, when an electrode assembly 10 of an identical diameter is formed, the positive electrode mixture layer 11b can be made longer to increase the battery capacity.

The negative electrode 12 is formed of a copper foil having an elongate shape, and comprises a negative electrode sheet 12a and a treated negative electrode portion, in which a negative electrode mixture layer 12b is formed on both surfaces of the negative electrode sheet 12a. A lower side edge of the negative electrode sheet 12a along the longitudinal direction is a portion 12c not-treated by the negative electrode mixture in which the negative electrode mixture layer 12b is not formed to leave an exposed copper foil. A plurality of negative electrode leads 17 extending in the direction opposite to the positive electrode leads 16 are formed integrally each at an equal diameter to the portion 12c not-treated by the negative electrode mixture.

The negative electrode mixture comprises a negative electrode active material, a negative electrode binder, and a viscosity improver. The negative electrode mixture may also contain a negative electrode conductive material such as acetylene black. As the negative electrode active material, graphite carbon, particularly, artificial graphite is used preferably. Particularly, a negative electrode mixture 12b of excellent characteristics can be obtained by the method to be described below. By using graphite carbon, a lithium ion secondary battery for plug-in hybrid vehicles or electric vehicles requiring large capacitance can be manufactured. The method of forming the negative electrode mixture layer 12b is not particularly restricted so long as the negative electrode mixture layer 12b is formed on the negative electrode sheet 12a. An example of coating the negative electrode mixture to the negative electrode sheet 12a includes a method of coating a dispersed solution of the constituent material of the negative electrode mixture on the negative electrode sheet 12a. An example of the coating method includes a roll coating method, a slit die coating method, etc.

As an example of forming the negative electrode mixture layer 12b on the negative electrode sheet 12a, a slurry formed by adding N-methyl-2-pyrrolidone or water as a dispersing solvent to a negative electrode mixture and kneading them is coated uniformly on both surfaces of a rolled copper foil of 10 μm thickness and dried, and then they are cut. The coating thickness of the negative electrode mixture is, for example, about 40 μm on one side. When the negative electrode sheet 12a is cut, negative electrode leads 17 are formed integrally. The length for all of the negative electrode leads 17 is substantially identical. After forming the negative electrode leads 17 by cutting, the negative electrode mixture layer 12b is preferably hot pressed by press rollers to increase the contact surface between the particles of the negative electrode mixture and with the negative electrode sheet 12a to lower a direct current resistance. Further, since the thickness of the negative electrode mixture layer 12b is decreased by hot pressing, when an electrode assembly 10 of an identical diameter is formed, the negative electrode mixture layer 12b can be made longer to increase the battery capacitance.

The width WS of the first separator 13 and that of the second separator 14 are formed larger than the width WC of the negative electrode mixture layer 12b formed to the negative electrode sheet 12a. Further, the width WC of the negative electrode mixture layer 12b formed to the negative electrode sheet 12a is formed larger than the width WA of the positive electrode mixture layer 11b formed to the positive electrode sheet 11a.

Since the width WC of the negative electrode mixture layer 12b is larger than the width WA of the positive electrode mixture layer 11b, internal short-circuit caused by deposition of obstacles is prevented. In the lithium ion secondary battery, while lithium as the positive electrode active material is ionized and penetrates the separator, if the negative electrode mixture layer 12b is not formed on the side of the negative electrode sheet 12a to expose the negative electrode 12a to the positive electrode mixture layer 11b, lithium is precipitated to the negative electrode sheet 12a to cause occurrence of internal short-circuit.

Each of the first and the second separators 13 and 14 is, for example, a porous film made of polyethylene of 40 μm thickness.

In FIG. 1 and FIG. 3, a step 15a of a diameter larger than the inner diameter of the axial core 15 is formed axially to the inner surface at the upper end of the hollow axial core 15 (vertical direction in the drawing), and a positive electrode collector member 27 is press fit into the step 15a.

The positive electrode collector member 27 is formed, for example, of aluminum and has a disk-shaped base portion 27a, a lower cylindrical portion 27b protruding toward the axial core 15 at the planar inner peripheral portion of the base portion 27a directed to the electrode assembly 10 and press fit into the inner surface of the step 15a of the axial core 15, and an upper cylindrical portion 27c protruding at the outer peripheral edge toward the battery lid 3. Openings 27d for releasing a gas generated in the battery due to overcharge, etc. are formed in the base portion 27a of the positive electrode collector member 27 (refer to FIG. 2). Further, an opening 27e is formed to the positive electrode collector member 27. The function of the opening 27e is to be described later. The axial core 15 is formed of such a material that is electrically insulated from the positive electrode collector member 31 and the negative electrode collector member 21 and increases the axial rigidity of the battery. The material used for the axial core 15 in this embodiment is, for example, a glass fiber reinforced polypropylene.

All of the positive electrode leads 16 of the positive electrode sheet 11a are welded to the upper cylindrical portion 27c of the positive electrode collector member 27. In this case, as illustrated in FIG. 2, the positive electrode leads 16 are overlapped and joined to the upper cylindrical portion 27c of the positive electrode collector member 27. Since each of the positive electrode leads 16 is extremely thin, a large current cannot be taken out through one lead. Accordingly, a number of positive electrode leads 16 are formed each at a predetermined distance over the entire length from the winding top to the winding end of the positive electrode sheet 11a relative to the axial core 15.

The positive electrode leads 16 of the positive electrode sheet 11a and a retainer member 28 are welded to the outer periphery of the upper cylindrical portion 27c of the positive electrode collector member 27. A number of positive electrode leads 16 are in close contact with the outer periphery of the upper cylindrical 27c of the positive electrode collector member 27, the retainer member 28 is wound around and temporarily fixed to the outer periphery of the positive electrode leads 16, and they are welded in this state.

A step 15b having an outer diameter smaller than the outer profile of the axial core 15 is formed to the outer periphery at the lower end of the axial core 15, and the negative electrode collector member 21 is press fit into and secured to the step 15b. The negative electrode collector member 21 is formed, for example, of copper of low resistance. An opening 21b to be press fit into the step 15b of the axial core 15 is formed to the disk-shaped base portion 21a and an outer peripheral cylindrical portion 21c protruding toward the bottom of the battery can 2 is formed at the outer peripheral edge.

All of the negative electrode leads 17 of the negative electrode sheet 12a are welded by supersonic welding or the like to the outer peripheral cylindrical portion 21c of the negative electrode collector member 21. Since each of the negative electrode leads 17 is extremely thin, a number of them are formed each at a predetermined distance from the winding top to the winding end of the negative electrode sheet 12a relative to the axial core 15.

The negative electrode leads 17 of the negative electrode sheet 12a and a retainer member 22 are welded to the outer periphery of the outer peripheral cylindrical portion 21c of the negative electrode collector member 21. A number of negative electrodes 17 are in close contact with the outer periphery of the outer cylindrical member 21c of the negative electrode collector member 21, the retainer member 22 is wound in a ring-shape and temporarily fixed around the outer periphery of the negative electrode lead 17, and they are welded in this state.

A negative electrode current supply lead 23 comprising nickel is welded to the lower surface of the negative electrode collector member 21.

The negative electrode current supply lead 23 is welded to the battery can 2 made of iron at the bottom of the battery can 2.

The opening 27e formed in the positive electrode collector member 27 serves to insert, therethrough, an electrode bar (not illustrated) used for welding the negative electrode current supply lead 23 to the battery can 2. The electrode bar is inserted from the opening 27e formed in the positive electrode collector member 27 into the hollow portion of the axial core 15 and urges, by the top end thereof, the negative electrode current supply lead 23 to the inner bottom surface of the battery can 2, and resistance welding is performed in this state. The battery can 2 connected to the negative electrode collector member 21 serves as one of output terminals of the cylindrical secondary battery 1, and electric power charged in the electrode assembly 10 can be taken out of the battery can 2.

A number of positive electrode leads 16 welded to the positive electrode collector member 27 and a number of negative electrode leads 17 welded to the negative electrode collector member 21 constitute a power generation unit 20 in which the positive electrode collector member 27, the negative electrode collector member 21, and the electrode assembly 10 are integrally formed as a unit (refer to FIG. 2). For the convenience of illustration, the negative electrode collector member 21, the retainer member 22, and the negative electrode current supply lead 23 are illustrated separately from the power generation unit 20 in FIG. 2.

Further, a flexible connection member 33 comprising a plurality of laminated aluminum foils is joined at one end by welding to the upper surface of the base portion 27a of the positive electrode collector member 27. By laminating to integrate a plurality of the aluminum foils, the connection member 33 can supply a large current and the member is made flexible.

A ring-shaped insulation plate 34 comprising an insulating resin material having a circular opening 34a is disposed above the upper cylindrical portion 27c of the positive electrode collector member 27.

The insulation plate 34 has an opening 34a (refer to FIG. 2) and a side portion 34b protruding downward. A connection plate 35 is engaged in the opening 34a of the insulation plate 34. The other end of the flexible connection member 33 is fixed by welding to the lower surface of the connection plate 35.

The connection plate 35 is formed of an aluminum alloy and has a substantially dish-like shape, which is substantially uniform entirely excluding a central portion and distorted to a somewhat downward position at the central portion. A protrusion 35a which is thin and formed into a dome shape is formed at the central portion of the connection plate 35, and a plurality of openings 35b are formed at the periphery of the protrusion 35a (refer to FIG. 2). The openings 35b serve to release a gas generated in the battery due to overcharge, etc.

The protrusion 35a of the connection plate 35 is joined to the bottom at the central portion of a diaphragm 37 by resistance welding or friction diffusion welding. The diaphragm 37 is formed of an aluminum alloy and has a circular recess 37a around the central portion of the diaphragm 37 as a center. The recess 37a is formed by crushing the upper surface into V- or U-shaped configuration by pressing while reducing the thickness of the remaining portion.

The diaphragm 37 is provided for ensuring the safety of the battery. When a pressure of a gas evolved inside the battery increases, the diaphragm warps upward to be spaced apart from the connection plate 35 by peeling the joint with the protrusion 35a of the connection plate 35 and disconnects conduction with the connection plate 35 in the first stage. When the inner pressure of the battery still increases, the diaphragm is torn at the recess 37a to release the gas inside to lower the internal pressure in the second stage.

The diaphragm 37 fixes, at the peripheral edge thereof, the peripheral edge 3a of the battery lid 3. As illustrated in FIG. 2, the diaphragm 37 initially has a side 37b upstanding vertically to the battery lid 3 at the peripheral edge. The battery lid 3 is contained in the lateral side 37b, and the lateral side 37b is bent and fixed on the side of the upper surface of the battery lid 3 by crimping.

The battery lid 3 is formed of an iron material such as carbon steel and applied with a plating layer comprising, for example, nickel over the entire surface on the outside and the inside. The battery lid 3 has a hat-shape having a disk-like peripheral edge 3a in contact with the diaphragm 37 and a head portion 3b protruding upward from the peripheral edge 3a. An opening 3c is formed in the head portion 3b. The opening 3c serves to release a gas to the outside of the battery when the diaphragm 37 is torn by a pressure of the gas generating inside the battery.

The battery lid 3, the diaphragm 37, the insulation plate 34, and the connection plate 35 are integrated to constitute a battery lid unit 30.

As described above, the connection plate 35 of the battery lid unit 30 is connected with the positive electrode collector member 27 by way of the connection member 33. Accordingly, the battery lid 3 is connected with the positive electrode collector member 27. As described above, the battery lid 3 connected to the positive electrode collector member 27 serves as the other output terminal and an electric power charged in the electrode assembly 10 can be outputted from the battery lid 3 serving as the other output terminal and the battery can 2 serving as one output terminal.

A seal member 43 usually referred to as a gasket is provided while covering the peripheral edge of the lateral side 37b of the diaphragm 37. The seal member 43 is formed of rubber and an example of a preferred material includes a fluoro resin although the member is not intended to be restricted thereto.

The seal member 43 initially has a shape having an outer peripheral wall 43b upstanding substantially vertically at the peripheral edge of the ring-shaped base portion 43a as illustrated in FIG. 2.

Then, the outer peripheral wall 43b of the seal member 43 are bent together with the battery can 2 and crimped, for example, by pressing so as to press contact the diaphragm 37 and the battery lid 3 in the axial direction by the base portion 43a and the outer peripheral wall 43b. Thus, the battery lid unit 30 comprising the battery lid 3, the diaphragm 37, the insulation plate 34, and the connection plate 35 which are formed integrally is fixed by way of the seal member 43 to the battery can 2.

A non-aqueous electrolyte 6 is injected by a predetermined amount to the inside of the battery can 2. As an example of the non-aqueous electrolyte 6, a solution in which a lithium salt is dissolved in a carbonate type solvent is used preferably. The lithium salt includes, for example, lithium hexefluoro phosphate (LiPF₆), lithium tetrafluoro borate (LiBF₄), etc. The example of the carbonate type solvent includes ethylene carbonate (EC), dimethyl carbonate (DMC), propylene carbonate (PC), methyl ethyl carbonate (MEC), or a mixture of solvents selected from two or more of the solvents described above.

### (Structure of Electrode Assembly)

Then, the structure of the electrode assembly is to be described specifically.

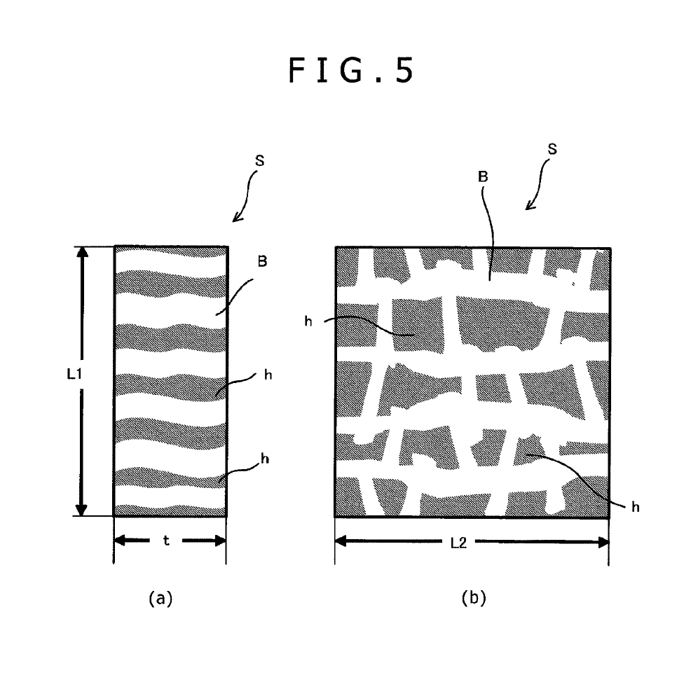

FIG. 5 is a view for explaining the porosity of a separator constituting the electrode assembly 10 illustrated in FIG. 3 in which (a) is an enlarged cross sectional view and (b) is an enlarged plan view.

In the separator, both of the first separator 13 and the second separator 14 have an identical structure and they are typically represented by a separator S.

The separator S has a number of pores h penetrating a base material B in the direction of the thickness.

The porosity c of the separator is calculated according to the following equation (1).

Porosity c={1−(W/ρ)/(L1×L2×t)} equation (1)

W: weight of test specimen
ρ: density of test specimen
L1: width of test specimen (length in the lateral surface)
L2: entire length of test specimen (length of a side different from the L1 in a plane)
t: thickness of test specimen (length of a side different from the L1 in the lateral surface)

Explanation is to be supplemented for the entire length L2 of the test specimen. The top end of the separator S is situated in the winding top at a position near the axial center from the top end of the negative electrode 12 and a region from the top end of the separator S to the top end of the negative electrode 12 is referred to as a preceding winding region. Further, the rear end of the separator S is situated on the winding end at a position outside to the rear end of the negative electrode 12, and a region from the rear end of the separator S to the rear end of the negative electrode 12 is referred to as a succeeding winding region. The entire length of the separator S means a length including a region corresponding to the negative electrode 12, and the preceding winding region and the succeeding winding region.

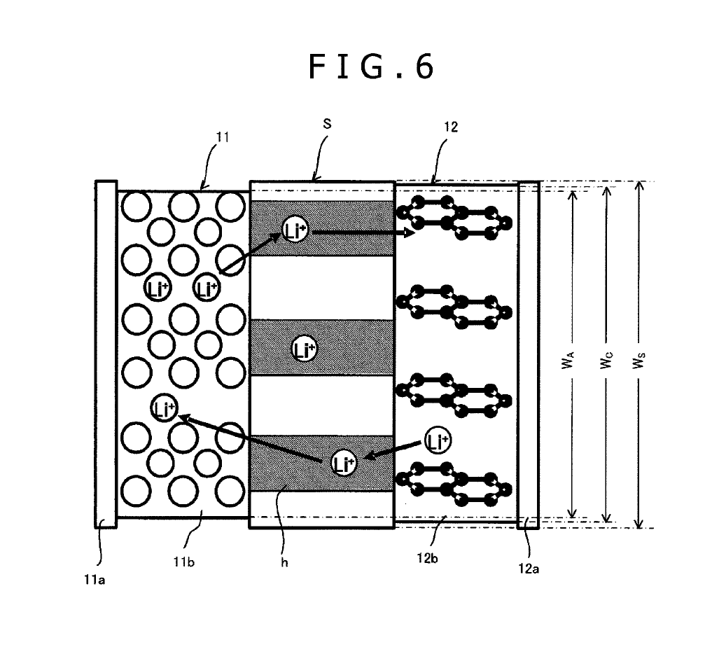

FIG. 6 is an enlarged cross sectional view for explaining the effect of the invention.

As has been described above, the electrode assembly 10 is formed by stacking and winding the negative electrode 12, the first separator 13, the positive electrode 11, and the second separator 14 in this order around the axial core 15.

That is, the positive electrode 11 and the negative electrode 12 are opposed to each other by way of the first separator 13 or the second separator 14 (they are typically represented by the separator S).

A positive electrode mixture layer 11b is formed on both surfaces of a positive electrode sheet 11a of a positive electrode 11 and a negative electrode mixture layer 12b is formed on both surfaces of a negative electrode sheet 12a of a negative electrode 12. Thus, the positive electrode mixture layer 11b and the negative electrode mixture layer 12b are opposed to each other by way of the separator S. The width WC of the negative electrode mixture layer 12b is larger than the width WA of the positive electrode mixture layer 11b and the width WS of the separator S is larger than the width WC of the negative electrode mixture layer 12b.

As has been described above, a number of pores h are formed in the separator S.

In the lithium ion secondary battery 1, an effect so-called insertion or intercalation is caused upon charging, in which the positive electrode active material contained in the positive electrode mixture layer 11b is reacted with the non-aqueous electrolyte 6 to form lithium ions, which move by way of the pores h in the separator S to the negative electrode 12 and migrate into the inside of the negative electrode 12. On the other hand, an effect so-called extraction or deintercalation is caused during discharging, in which the lithium ions exit from the negative electrode 12 and migrate by way of the pores h in the separator S into the positive electrode 11. Both in the cases of insertion (intercalation) and extraction (deintercalation), the lithium ions are not precipitated to the surface of the negative electrode 12 or the positive electrode 11.

Generally, in the lithium ion secondary battery 1, when the separator S has thin film thickness, large pore diameter, high porosity, and high permeability, lithium ions move easily and the ion permeability is high. However, since the film density becomes lower, the physical strength is deteriorated. By the technical level at present, it is difficult to manufacture a separator S having the porosity exceeding 50% in view of the physical strength.

On the other hand, when the separator S has a large film thickness, small pore diameter, low porosity, and low permeability, the physical strength is improved along with increase in the film density. On the other hand, movement of lithium ions becomes difficult.

Referring to FIG. 6, the amount of the non-aqueous electrolyte possessed between the positive electrode mixture layer 11b and the negative electrode mixture layer 12b changes depending on the area of the positive electrode mixture layer 11b, in other words, the area of power generation portion and the area of the pores in the separator S. Since the amount of the electrolyte possessed between the positive electrode mixture layer 11b and the negative electrode mixture layer 12b gives an effect on the reaction with the positive electrode active material in the positive electrode mixture layer 11b, it is considered to have a concern with the battery output.

Then, the present invention intends to improve the battery output based on the relation of the battery output to the ratio of the area of the positive electrode mixture layer 11b, that is, the area of power generation portion and the pore area in the separator S.

### Example 1

In Example 1, a plurality of lithium ion secondary batteries 1 satisfying a relation: b×c/a=0.598 were manufactured assuming the area of a positive electrode mixture layer as a, the area of a separator as b, and the porosity of a separator as c (porosity c in the separator in Example 1 is 47).

### Example 2

In Example 2, a plurality of lithium ion secondary batteries 1 satisfying a relation: b×c/a=0.582 were manufactured assuming the area of the positive electrode mixture layer as a, the area of the separator as b, and the porosity of the separator as c (porosity c in the separator in Example 2 is 47).

### Example 3

In Example 3, a plurality of lithium ion secondary batteries 1 satisfying a relation: b×c/a=0.587 were manufactured assuming the area of the positive electrode mixture layer as a, the area of the separator as b, and the porosity of the separator as c (porosity c in the separator in Example 3 is 47).

### Example 4

In Example 4, a plurality of lithium ion secondary batteries 1 satisfying a relation: b×c/a=0.581 were manufactured assuming the area of the positive electrode mixture layer as a, the area of the separator as b, and the porosity of the separator as c (porosity c in the separator in Example 4 is 45).

### Comparative Example

For comparison, a plurality of lithium ion secondary batteries of a conventional structure at: b×c/a=0.549 were manufactured (the porosity c in the separator of the comparative example was 45).

### (Confirmation of Effect)

Initial output was measured to evaluate the output characteristics for every plurality of lithium batteries in each of Examples 1 to 4 and the comparative example manufactured as described above.

In the measurement for the initial output, each of the batteries was discharged from the completely charged state at 4.1 V at current values of 10 A, 30 A, and 90 A for 10 seconds in an atmosphere at 25±2° C., and the battery voltage was measured each at 10 second. The battery voltage was plotted on the ordinate relative to the current value on the abscissa, and a current value at the intersection between an approximate straight line prepared for three points and a final voltage of 2.7 V was read. A value obtained by dividing the product of the current value and 2.7 V by a battery weight was defined as the output density of the lithium ion secondary battery 1.

The result is shown in Table 1. The value of the output (relative value) shown in Table 1 is a relative value of the power density in each of the examples with reference to the power density of the comparative example being assumed as 100, which is shown by an average for the measured values in each of the examples. Throughout the test, separators S having a thickness t of 18 to 25 μm were used and it was confirmed that the difference of the thickness t gives a scarce effect on the increase and decrease of the battery output.

TABLE 1

| | Porosity | | Output |
|---|---|---|---|
| | c | b × c/a | (relative value) |
| Example 1 | 47 | 0.598 | 111 |
| Example 2 | 47 | 0.582 | 111 |
| Example 3 | 47 | 0.587 | 111 |
| Example 4 | 45 | 0.581 | 106 |
| Comparative | 45 | 0.549 | 100 |
| Example | | | |

Example 1 to Example 3 showed satisfactory output characteristics of 111% (relative value) of power density with reference to the comparative example. Further, in Example 4 and the comparative example, while the porosity c was identical as 45 for both of them, Example 4 showed a higher effect of the power density at 106% relative to the comparative example.

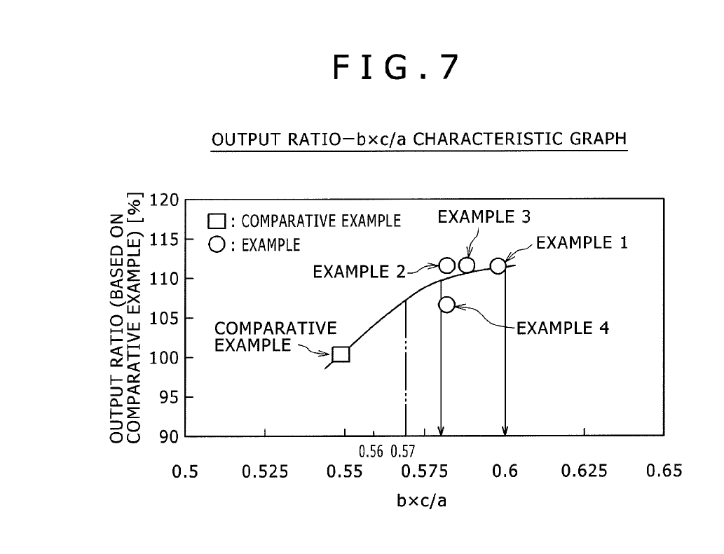

Further, the content of Table 1 is shown by an output ratio—b×c/a characteristic graph in FIG. 7.

In FIG. 7, relative values of a power density with reference to the comparative example were plotted on the ordinate relative to b×c/a on the abscissa.

With reference to Table 1 and FIG. 7, increase in the battery power density (output ratio) is concerned with the porosity c but the battery power density sometimes varies even when the porosity c is identical as in the case of Example 4 and the comparative example, and it can be seen that the power density cannot be determined only based on the porosity c.

The battery power density rather has a closer relation with the value of b×c/a.

In view of the output ratio—b×c/a characteristic curve shown by a solid line, it can be seen that the output ratio at a value of b×c/a of 0.57 is substantially equal or more than that of Example 4 and the battery power density increases more than usual.

Further, in the output ratio—b×c/a characteristic curve in FIG. 7, the output ratio is substantially at a constant value (about 111%) near the value of b×c/a of about 0.6 and the power density scarcely increases if the b×c/a value exceeds 0.6.

Accordingly, when the b×c/a value is defined as 0.57 to 0.60, the output characteristics can be improved more than those in the usual case.

In this case, when Examples 1 to 3 and Example 4 are compared, the battery power density is higher when the porosity of the separator is at c=47 than in the case when the porosity is at c=45. Accordingly, when the porosity c is more than 47, it is easy to obtain the b×c/a value within the range of 0.57 to 0.60. As has been described above, since it is difficult to manufacture a separator S with the porosity c exceeding 50 by the technical level at present, the porosity at c=50 is a substantial upper limit.

Further, when the porosity c of the separator S is less than 43, it is confirmed that battery performance such as battery life and battery capacitance are considerably deteriorated. Accordingly, the porosity at: c=43 is a substantial lower limit.

In view of the above, the following results are obtained.

(1) Assuming the area of the positive electrode mixture layer 11b as a, the area of the separator S as b, and the porosity of the separator S as c, a lithium ion secondary battery having a higher battery power density than usual can be obtained by satisfying the relation shown by the following formula:

0.57<b×c/a<0.60 (I)

When the value b×c/a is within the range of the relation (I) described above, it does not show that this is a threshold value of 100% or more for the power density relative to the conventional case. When the value b×c/a is within the range of the relation (I) described above, this is sufficient to attain a higher power density than the conventional power density and shows that manufacture of the lithium ion secondary battery is easy.

(2) When the porosity c of the separator S is from 43 to 50, a lithium ion secondary battery satisfying the relation (I) can be manufactured easily.

(3) The thickness t of the separator S has no close relation with the level of the battery power density.

Accordingly, the thickness may be reduced sufficiently with a view point of increasing the battery capacity. In Examples 1 to 4, the thickness of the separator was defined as t=18 to 25 μm.

As described above, in the lithium ion secondary battery according to the invention, since the ratio is optimized between the area of the positive electrode mixture layer and the pore area in the separator, an appropriate amount of the non-aqueous electrolyte is possessed between the positive electrode mixture layer and the negative electrode mixture layer to reduce the resistance between the positive electrode and the negative electrode. This can improve the battery power density.

In the embodiment described above, the lithium ion secondary battery has been described for the cylindrical secondary battery as the embodiment. However, the invention is applicable also to a square lithium ion secondary battery.

In addition, the lithium ion secondary battery of the invention is applicable with various modifications within the range of the gist of the invention providing that, in the lithium ion secondary battery in which an electrode assembly is accommodated in the battery container, the electrode assembly including a positive electrode having a positive electrode mixture layer containing a lithium transition metal composite oxide, a negative electrode having a negative electrode mixture layer occluding/releasing lithium ions, and a separator disposed to the inner and outer peripheries of the positive electrode and the negative electrode, the lithium ion secondary battery being charged with a non-electrolyte containing a lithium salt, the value of b×c/a is within a predetermined range assuming the area of the positive electrode mixture layer as a, the area of the separator as b, and the porosity of the separator as c.

While various embodiments and modified examples have been described above, the present invention is not restricted to the contents thereof. Other embodiments considered within the range of the technical idea of the invention are also included in the range of the invention.

The contents of the disclosure in the following application as a base for claiming the priority right are incorporated herein for reference.

Japanese Patent Application No. 2010-288257 (filed on Dec. 24, 2010).

1. A lithium ion secondary battery in which an electrode assembly is accommodated in a battery container, the electrode assembly including a positive electrode having a positive electrode mixture layer containing a lithium transition metal composite oxide, a negative electrode having a negative electrode mixture layer for occluding/releasing lithium ions, and a separator disposed to inner and outer peripheries of the positive electrode and the negative electrode, the lithium ion secondary battery being charged with a non-aqueous electrolyte containing a lithium salt, wherein a relation shown by the following formula (I) is satisfied:
0.581<b×c/a<0.60 (I)
assuming the area of the positive electrode mixture layer as a, the area of the separator as b, and the porosity of the separator as c.

2. The lithium ion secondary battery according to claim 1, wherein
the electrode assembly has a cylindrical shape and the area of the separator includes an area of a preceding winding region and an area of a succeeding winding region.

3. The lithium ion secondary battery according to claim 1, wherein
the separator has a porosity of 43 to 50.

4. The lithium ion secondary battery according to claim 1, wherein
the separator has a porosity of 45 to 50.

5. The lithium ion secondary battery according to claim 1, wherein
the separator has a thickness of 18 to 25 μm.

6. The lithium ion secondary battery according to claim 2, wherein
the separator has a porosity of 43 to 50.

7. The lithium ion secondary battery according to claim 2, wherein
the separator has a porosity of 45 to 50.

8. The lithium ion secondary battery according to claim 2, wherein
the separator has a thickness of 18 to 25 μm.

9. The lithium ion secondary battery according to claim 3, wherein
the separator has a thickness of 18 to 25 μm.

10. The lithium ion secondary battery according to claim 4, wherein
the separator has a thickness of 18 to 25 μm.
